(19) United States
(12) Patent Application Publication
(10) Pub. No.: US 2004/0049546 A1
(43) Pub. Date: Mar. 11, 2004

(54) Mail processing system

(75) Inventor: Takeo Yoshida, Tokyo (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/379,908

(22) Filed: Mar. 6, 2003

(30) Foreign Application Priority Data
Sep. 11, 2002 (JP) 2002-265302

(51) Int. Cl. G06F 15/16

(52) U.S. Cl. 709/206

(57) ABSTRACT

The present invention provides a mail processing system which reduces the load on an e-mail hosting. A center-side mail server (30) receives electronic mail addressed to client domains (10) and combines the electronic mail into one file (bulk mail data) for each domain. A client-side mail server (14) in the client domain (10) regularly accesses the center-side mail server (30) to download the bulk mail data, which is addressed to the client domain (10), from the server (30). The client-side mail server (14) disassembles the downloaded bulk mail data into individual electronic mail data and saves it in respective destination mailboxes. A user PC (16) in the client domain (10) can receive electronic mail, which is addressed to the user PC, from the client-side mail server (14) using a protocol such as POP3.

### BACKGROUND OF THE INVENTION

1. Field of the Invention

The present invention relates to a technology for reducing the load on a server providing electronic mail sending and receiving services to mail clients.

2. Description of the Related Art

Hosting services, such as those in which a company leases its own web server or mail server to its client companies, have become popular. Companies which find it difficult to install and manage their own servers commonly use hosting services.

For mail server hosting, the users of a client company use a protocol, such as POP3 or SMTP, to access the mail server for sending and receiving electronic mail. As the number of client companies increases and the number of users increases, the processing load on the mail server can grow very large. Although conventional solution to such a problem is the addition of mail servers to enhance processing power, this solution is expensive and increases the workload on the hosting company.

### SUMMARY OF THE INVENTION

The present invention advantageously provides a technology for reducing the load on a mail server.

A mail processing system according to the present invention comprises client-side mail servers each installed in a client organization for providing electronic mail processing services to mail clients in the client organization; and a center-side mail server providing electronic mail processing services to the client-side mail servers, wherein the center-side mail server comprises receiving means for receiving electronic mail, which is addressed to mail addresses within the client organization, on behalf of the client-side mail server of the client organization; storing means for storing the electronic mail received by the receiving means; and batch transfer means for transferring bulk mail data to the client-side mail server of the client organization, the bulk mail data being created by combining electronic mail, which is stored in the storing means and addressed to the mail addresses within the client organization, into one unit, and wherein the client-side mail server comprises batch receiving means for receiving the bulk mail data transferred from the center-side mail server; and individual-mail delivery means for delivering the electronic mail to the mail addresses within the client organization for which the client-side mail server is responsible based on the bulk mail data received by the batch receiving means.

This configuration allows the center-side mail server to deliver electronic mail to addresses within a client organization simply by forwarding electronic mail which is addressed to mail addresses within the client organization to the client-side mail server in a batch mode. Therefore, compared to a system in which the center-side mail server delivers electronic mail individually to individual mail clients in the client organization, the processing load on the center-side mail server is reduced.

In a preferred configuration of the invention, the client-side mail server further comprises means for sending a batch download request to the center-side mail server and, in response to the batch download request from the client-side mail server, the center-side mail server transfers the bulk mail data to the client-side mail server using the batch transfer means.

With this configuration, because bulk mail data is downloaded in response to a request from the client-side mail server, the client-side mail server need not always open an electronic mail receiving port. This makes it more difficult to access the network in the client organization via the client-side mail server, and therefore enhances network security of the client organization.

In another aspect of the present invention, the individual-mail delivery means of the client-side mail server restores the bulk mail data to individual electronic mail data, saves each electronic mail in a mailbox corresponding to a destination mail address and, in response to a request from a mail client in the client organization, delivers the electronic mail in a corresponding mailbox to the mail client.

The client-side mail server may restore received bulk mail data to electronic mail data and save the restored mail in mailboxes. This makes it possible for mail clients who use a conventional protocol such as POP3 to be treated as mail clients in the client organization.

### BRIEF DESCRIPTION OF THE DRAWINGS

FIG. 1 is a diagram showing an overview of a mail processing system according to the present invention;

FIG. 2 is a diagram showing example data of an assigned domain list;

FIG. 3 is a diagram showing an example of electronic mail data storage form in a center-side mail server;

FIG. 4 is a flowchart showing an example of processing when the center-side mail server receives electronic mail;

FIG. 5 is a flowchart showing an example of processing when a client-side mail server receives electronic mail from a mail client;

FIG. 6 is a flowchart showing an example of a processing procedure for transferring electronic mail data, received by the center-side mail server on behalf of a client-side mail server, to the client-side mail server;

FIG. 7 is a diagram showing example of an index table;

FIG. 8 is a diagram showing an example of a redundant system configuration where a plurality of center-side mail servers are provided; and

FIG. 9 is a diagram showing an example of correspondence information held by a network manager to indicate the correspondence between client domains and center-side mail servers.

### DESCRIPTION OF PREFERRED EMBODIMENT

A preferred embodiment of the present invention will be described with reference to the attached drawings.

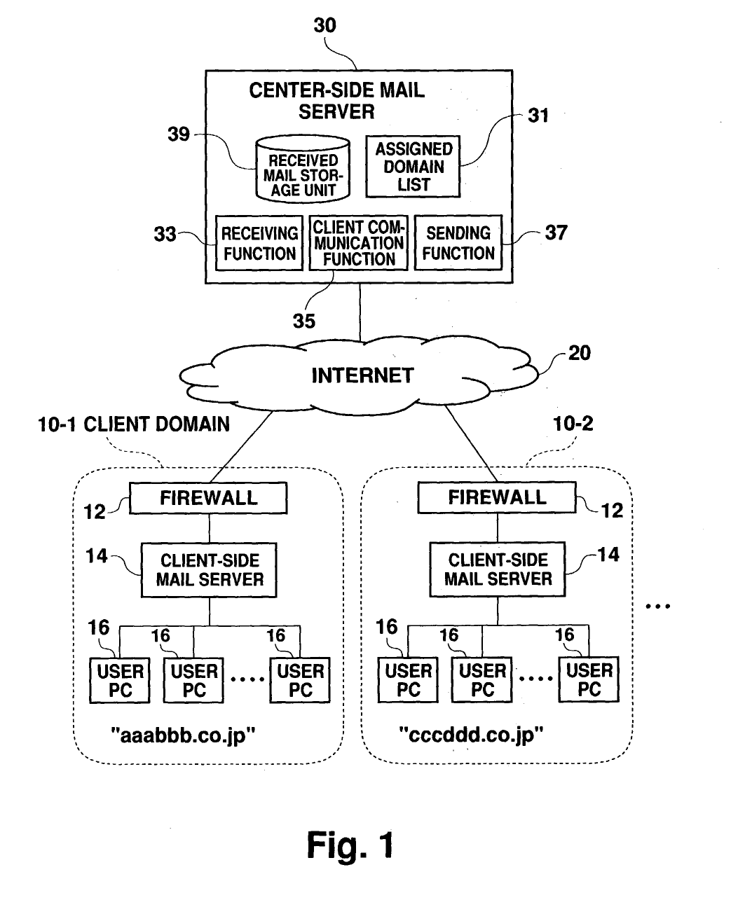

FIG. 1 is a diagram schematically showing an example mail processing system according to the present invention. In the illustrated example, a hosting service provider provides one or more client organizations with mail processing hosting services. It is assumed that each client organization has their own data communication network, such as a LAN (Local Area Network. The network within the client organization may be associated with one more top level domains registered with a NIC (Network Information Center), or with lower level domains (referred to herein as sub-domains) that are within a registered domain. For example, when a client organization is a department within a corporation, the client organization may operate a sub-domain of the corporation's top level domain. In the description below, client organization top level domains and sub-domains are generically referred to as a client domain (or simply a domain), unless otherwise stated.

As shown in FIG. 1, in the mail processing system in this embodiment, a client-side mail server 14 is provided in each of client domains 10-1, 10-2, etc., hereinafter generically referred to as the client domain 10. The client-side mail server 14 is connected to the Internet 20, for example, via a firewall 12. Each user PC (Personal Computer) 16 in the client domain 10 is connected to the client-side mail server 14 via an LAN built within the domain. A user within the client domain uses his or her own user PC 16 to send or receive electronic mail via the client-side mail server 14 in the domain. The user PC 16 is assumed to have a mail client software program employing a standard mail protocol, such as SMTP (Simple Mail Transfer Protocol) or POP3 (Post Office Protocol 3).

Also provided in this mail processing system is a center-side mail server 30 that provides the mail processing services to the client domains 10 for which the center-side mail server is responsible. Information on the client domains for which the center-side mail server 30 is responsible is included in an assigned domain list 31.

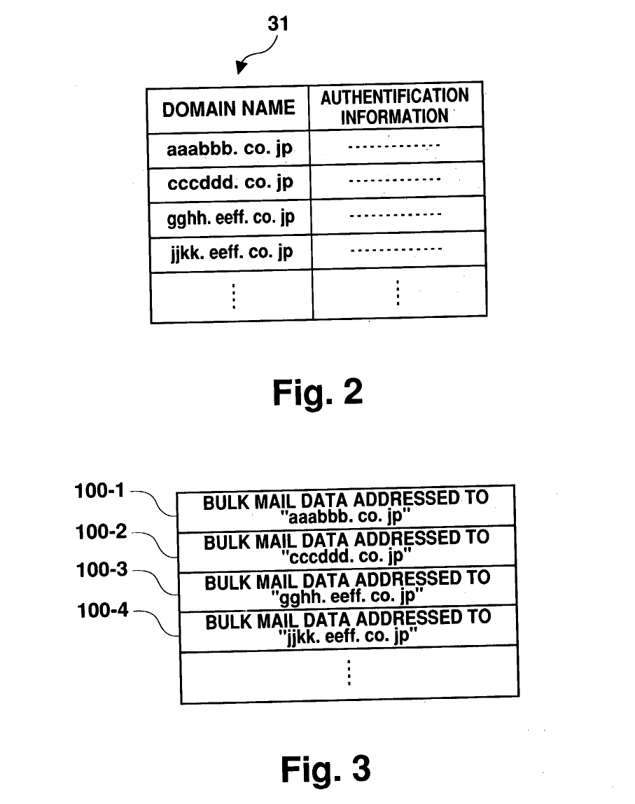

FIG. 2 is a diagram showing an example of the data structure of the assigned domain list 31. In this example, the assigned domain list 31 contains the domain name (or sub-domain name) and authentication information used to authenticate access for each client domain to which the center-side mail server 30 provides services.

The center-side mail server 30 comprises a receiving function 33, a client communication function 35, a sending function 37, and a received mail storage unit 39.

The receiving function 33 receives electronic mail sent to the client domains 10 for which the center-side mail server is responsible via the Internet 20, on behalf of the client-side mail servers 14. The electronic mail received by the receiving function 33 is stored in the received mail storage unit 39. As shown in FIG. 3, the received mail storage unit 39 contains received mail in the form of bulk mail data, 100-1, 100-2, 100-3, 100-4, . . . (hereinafter generically called bulk mail data 100), for each domain. The bulk mail data 100 is data in the form of a file containing the electronic mail addressed to mail addresses within a domain.

The client communication function 35 communicates with the client-side mail servers 14 in the client domains 10 for which the center-side mail server is responsible, forwards to the client-side mail servers 14 electronic mail data received via the Internet 20 on behalf of the client users, and receives electronic mail data uploaded from the client-side mail servers 14.

The sending function 37 sends electronic mail, which is uploaded from the client-side mail servers 14, to its destination via the Internet 20.

The IP address of the center-side mail server 30 is registered with the DNS (Domain Name System) server on the Internet 20 as the IP addresses corresponding to the client domains registered with the assigned domain list 31. Using this address setup, the electronic mail to be addressed to mail addresses belonging to the client domains or sub-domains registered with the assigned domain list 31 is sent to the center-side mail server 30.

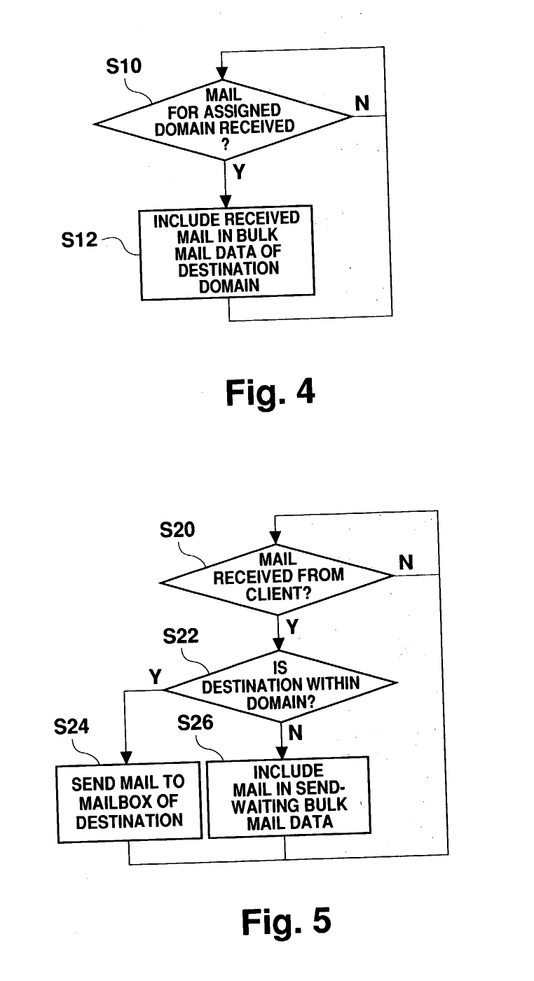

FIG. 4 is a flowchart showing an example of a processing procedure executed by the receiving function 33 of the center-side mail server 30.

The receiving function 33 of the center-side mail server 30, which employs a standard mail transfer protocol such as SMTP awaits receipt from the Internet 20 (S10). of electronic mail addressed to a client domain for which the center-side mail server 30 is responsible. The receiving function 33 references the assigned domain list 31 to determine that a domain is a client domain for which it is responsible. Upon receiving electronic mail addressed to a client domain for which the center-side mail server 30 is responsible, the receiving function 33 includes the electronic mail into the bulk mail data 100 corresponding to the domain or sub-domain to which the mail is addressed (S12). This inclusion is done, for example, by adding the received electronic mail data to the end of the bulk mail data. By repeating this processing, the center-side mail server 30 can receive electronic mail addressed to the mail address of each client domain and collectively store the received electronic mail as the bulk mail data 100 of the corresponding client domain.

As described above, in the present embodiment, electronic mail addressed to each client domain 10 is first stored in the center-side mail server 30. Similarly, electronic mail sent from a client domain 10 to external addresses is first stored in the client-side mail server 14 in the domain 10. This processing will be described with reference to FIG. 5. FIG. 5 shows a processing procedure executed by the mail sending function of the client-side mail server 14. The client-side mail server 14 provides the mail clients (user PCs 16) within the domain with services similar to those provided by a conventional standard mail server.

The mail sending function of the client-side mail server 14 receives mail to be sent from a mail client in the domain (S20). Upon receiving from a mail client mail to be sent, the mail sending function determines if the destination of the mail is an address within the domain (S22). If the destination mail address of the mail is an address within the domain, the mail sending function saves the mail in the mailbox of the mail address managed by the client-side mail server 14 (S24). If the destination of the mail to be sent is determined to be an address not within the domain in step S22, the client-side mail server 14 includes the mail in the send-waiting bulk mail data saved in the storage of the server 14 (S26). This send-waiting bulk mail data is a file containing electronic mail to be sent from the client domain 10, for which the client-side mail server 14 is responsible, to addresses external to the domain.

The bulk mail data 100, which is stored in the center-side mail server 30 as described above and addressed to each client domain 10, is transferred to the client domain in response to a download request from the client-side mail server 14 for delivery to a destination mail address within the client domain. On the other hand, bulk mail data stored in a client-side mail server 14 is uploaded from the client-side mail server 14 to the center-side mail server 30 to allow the sending function 37 of the center-side server 30 to forward the data to its destination. Electronic mail is sent to or received from the mail clients in the client domain 10 by ownload processing and upload processing, respectively, both regularly executed by a client-side mail server 14. Although the client-side mail server 14 regularly executes download processing and upload processing in the above description, execution of download processing or upload processing may be performed at a schedule decided according to other conditions.

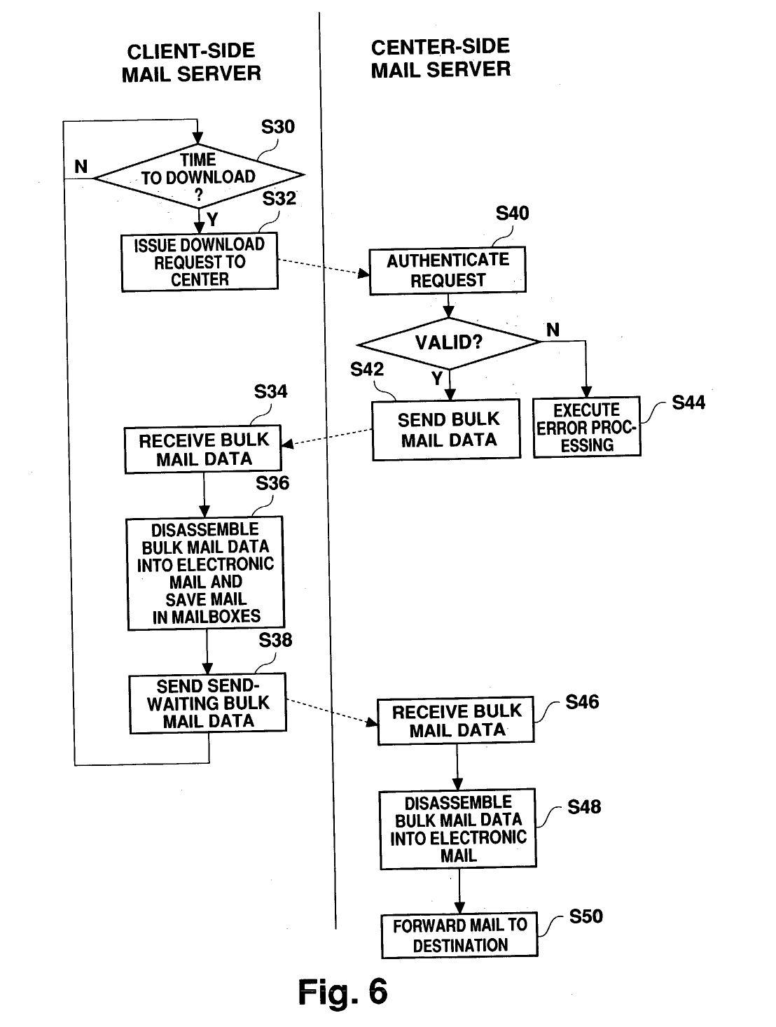

With reference to FIG. 6, the procedure for download processing and upload processing will be described. The client-side mail server 14 waits for a download time that satisfies a predetermined condition (S30) and then issues a download request to the center-side mail server 30 (S32). The client communication function 35 of the center-side mail server 30 responds with this request to execution authentication (S40). During this authentication processing, the client-side mail server 14 sends the domain name and authentication information to the center-side mail server 30. The client communication function 35 judges whether the download request is sent from a valid user based on the domain name and the authentication information. This authentication processing may be executed according to an appropriate known method. If the request is determined to be a request from an unauthorized user, the client communication function 35 executes error processing, for example, an error message is sent to the client-side mail server 14 that issued the download request (S44). However, if it is determined as a result of authentication in step S40 that the download request originates from an authorized user, the client communication function 35 obtains the bulk mail data 100 of the requesting client domain from the received mail storage unit 39 and sends the obtained data to the requesting client-side mail server 14 (S42). If the data is sent successfully, the client communication function 35 deletes the bulk mail data 100, which has been sent, from the received mail storage unit 39.

The client-side mail server 14 of the requesting client domain 10 receives the bulk mail data 100 sent from the center-side mail server 30 (S34). The client-side mail server 14 then disassembles the received bulk mail data 100 into electronic mail files and saves the disassembled electronic mail in the mailboxes provided for the electronic mail destination addresses managed by the client-side mail server 14 (S36). As a result of the processing steps described above, a mail client on each user PC 16 in the client domain 10 can obtain mail, addressed to its own mail address, from the client-side mail server 14 using a protocol such as POP3. In this way, electronic mail is distributed to mail addresses within the client domain 10.

After a sequence of mail reception processing, the client-side mail server 14 sends send-waiting bulk mail data, which is stored in its own storage device, to the center-side mail server 30 (S38). The client communication function 35 of the center-side mail server 30 receives the bulk mail data sent from the client-side mail server 14 (S46), disassembles the data into electronic mail (S48), and then passes the disassembled electronic mail to the sending function 37. The sending function 37 sends the electronic mail to destination mail addresses via the Internet 20 using a protocol such as SMTP (S50). In this way, electronic mail sent from the mail client in a client domain is delivered to its destination.

The procedure described above makes it possible for mail to be sent to or received from the users in the client domain 10. This embodiment only requires the center-side mail server 30 operated by a hosting service provider to send and receive bulk mail data, which is a collection of electronic mail to or from the client domain 10, to or from the client-side mail server 14. That is, compared with the conventional method in which the hosting-side mail server communicates individually with individual mail clients in the client domain 10 for mail transfer, the processing load on the hosting-side mail server (center-side mail server 30) can be significantly reduced when this embodiment is employed.

Another advantage of the present embodiment is that the client-side mail server 14 need not provide a mail sending and receiving port outside the firewall because the client-side mail server 14 accesses the center-side mail server 30 to download and upload mail. This configuration contributes to network security by making it extremely difficult to access the client domain 10 via the client-side mail server 14. In this way, this embodiment realizes an efficient and secure mail sending and receiving mechanism.

According to the procedure shown in FIG. 6, bulk mail data to be received is downloaded and bulk mail data to be sent is uploaded consecutively when a download time comes. However, the download time and the upload time may be decided independently.

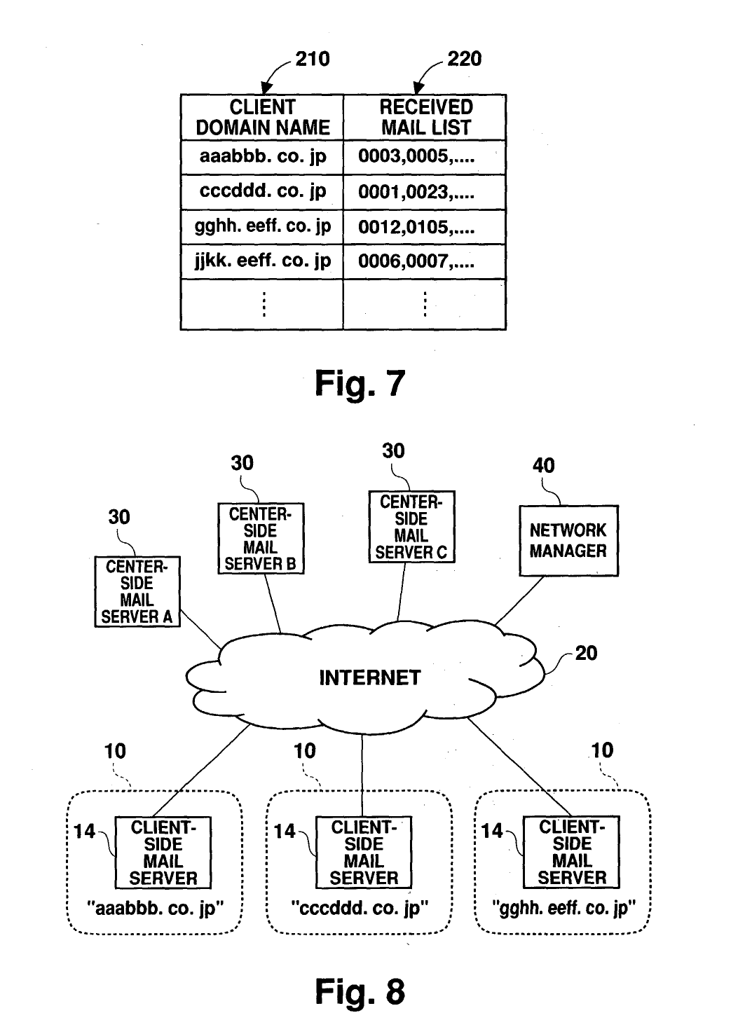

Although in the example described above the center-side mail server 30 includes in the bulk mail data addressed to the domain 10 electronic mail addressed to a mail address within that client domain 10, other procedures may be employed. For example, it is also possible that, upon receiving electronic mail, the center-side mail server 30 stores the mail on the received mail storage unit 39 in order of reception and, when a download request is received from a client-side mail server 14, the center-side mail server 30 may create bulk mail data addressed to the client-side mail server 14. According to this procedure, the receiving function 33 of the center-side mail server 30 need only create an index table having one entry for each client domain, such as the example shown in FIG. 7. The table shown in FIG. 7 is composed of entries each corresponding to a destination domain of received mail, with each client domain name 210 associated with a list of electronic mail identification information (received mail list 220) whose destination is an address in the domain. The electronic mail identification information is information indicating a location within the received mail storage unit 39 where mail is stored, for example, a numeric value indicating the sequence of storage of mail within the mail storage unit 39. The center-side mail server 30 stores each received electronic mail in the received mail storage unit 39 and registers the identification information with the received mail list 220 in an index table corresponding to the client domain of the mail destination. When a download request is received from a client-side mail server 14, the center-side mail server 30 references the index table to identify the mail addressed to the domain of that server 14, retrieves the mail from the received mail storage unit 39, and uses the retrieved mail to create bulk mail data.

In the above example, electronic mail issued from a client domain 10 is first sent from the client-side mail server 14 to the center-side mail server 30 as bulk mail data and then sent from the center-side mail server 30 to the destination. Instead, the client-side mail server 14 may also send the mail directly to the destination not via the center-side mail server 30.

A plurality of center-side mail servers 30 may be provided to serve a greater number of client domains and, at the same time, minimize the effect of a service shutdown caused by a server failure or the like. FIG. 8 is a diagram showing an example of the system configuration in which a plurality of center-side mail servers 30 are provided. Each center-side mail server 30 stores a list of client domains 10 (see FIG. 2) for which it is responsible and, at the same time, each client-side mail server 14 stores information on the center-side mail server 30 responsible for that domain. In addition, a network manager 40 is provided on the Internet 20 for supervising the system status in this embodiment. This network manager 40 manages information on the correspondence between the client domains 10 in the whole system and center-side mail servers 30 responsible for the domains.

In this embodiment, one primary center-side mail server and one or more secondary center-side mail servers are provided as the center-side mail servers 30 responsible for one client domain 10. The primary center-side mail server 30 receives electronic mail addressed to the client domain 10 and combines them into bulk mail data for management and, at the same time, communicates with the client-side mail server 14 to send and receive the bulk mail data. The secondary center-side mail servers 30, which usually do not communicate with the client domain 10, store the bulk mail data addressed to the client for which the primary center-side mail server 30 is responsible in order to provide a backup in the event of failure of the primary center-side mail server. The bulk mail data stored on the primary center-side mail server is synchronized with that stored on secondary center-side mail servers by sending bulk mail data addressed to the client domain 10 (or difference between the current bulk mail data and previous bulk mail data) from the primary center-side mail server 30 to the corresponding secondary center-side mail servers 30 at regular intervals or when the main center-side mail server receives mail addressed to the client domain 10. To implement this synchronization processing, the primary center-side mail server 30 stores information on the secondary center-side mail servers 30 responsible for the same client domain.

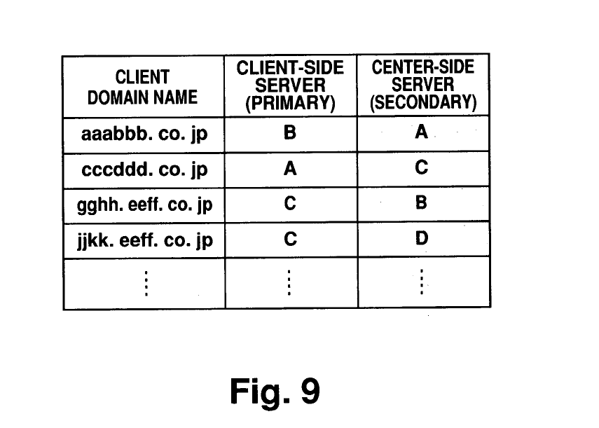

The center-side mail servers 30 and the client-side mail servers 14 regularly access the network manager 40. The manager 40 checks whether or not access is made or whether or not data is transferred at access time to determine if the center-side mail servers 30 and the client-side mail servers 14 are operating normally. Upon detecting that a failure has occurred in a center-side mail server 30, the manager 40 searches for a client domain 10 for which the failed server 30 has been responsible and, if such a client domain 10 is found, sends an instruction to the secondary center-side mail server 30 (or one of multiple servers) to request secondary center-side mail server 30 to act as the primary center-side mail server for the client domain 10. In conjunction with this instruction, the manager 40 sends to the new primary center-side mail server information indicating the secondary center-side mail server 30 which will act as the secondary center-side mail server of the client domain 10. The manager 40 modifies the information registered with the DNS server so that electronic mail addressed to the client domain will be delivered to the center-side mail server 30 that has become the new primary center-side mail server. The manager 40 also updates the correspondence information (see FIG. 9) held in the manager 40 to reflect this modification. A client-side mail server 14 which regularly accesses the manager 40 can obtain the latest information on the center-side mail server 30 responsible for the domain. Therefore, even when the primary center-side mail server 30 moves from one server to another, the client-side mail server 14 is able to correctly access the new primary center-side mail server 30 to receive bulk mail data addressed to the domain.

The network manager 40 is provided in the example described above, and in that example the client-side mail servers 14 access the manager 40 to obtain information on the center-side mail server 30 responsible for the client-side mail server to check for any change in the center-side mail server assignment. Instead of this configuration, it is also possible for the center-side mail server 30 which has assumed responsibility as the new primary center-side mail server to send information to the client-side mail server to indicate that center-side mail server has been changed. It may be desirable that a secure communication line be used to send this information.

In some cases, the center-side mail server 30 may designate a new folder or rename the file in which bulk mail data is stored. A system configured such that information on any changes is sent from the center-side mail server 30 to the client-side mail servers 14 would suitably address such situations.

The devices and the system in the examples described above may be implemented by software which describe the function of the servers and the processing procedures; a computer system comprising a CPU, a memory, external storage units such as a hard disk; and various input/output devices such as a network interface. In such a configuration, the software causes the CPU to control the devices so that mail data received via the network interface is first stored in a memory for processing before being written on a storage device such as a hard disk. Naturally, this is only one example of a computer program or software, and the software of programs for realizing the present invention are not limited to this example.

While there has been described what is at present considered to be a preferred embodiment of the invention, it will be understood that various modifications may be made thereto, and it is intended that the appended claims cover all such modifications as fall within the true spirit and scope of the invention.

What is claimed is:

1. A mail processing system providing electronic mail services, comprising:
client-side mail servers operated by a client organization for providing electronic mail processing services to mail clients within the client organization; and
a center-side mail server providing electronic mail processing services to the client-side mail servers,
wherein said center-side mail server comprises:
receiving means for receiving electronic mail addressed to mail addresses within the client organization, on behalf of the client-side mail server of the client organization;
storing means for storing the electronic mail received by said receiving means; and
batch transfer means for transferring bulk mail data to the client-side mail server of the client organization, said bulk mail data created by combining electronic mail stored on said storing means and addressed to the mail addresses within said client organization into a single unit, and
wherein said client-side mail server comprises:
batch receiving means for receiving the bulk mail data transferred from said center-side mail server; and
individual-mail delivery means for delivering the electronic mail to the mail addresses within the client organization for which said client-side mail server is responsible based on the bulk mail data received by said batch receiving means.

2. The mail processing system according to claim 1,
wherein said client-side mail server further comprises means for sending a batch download request to said center-side mail server and
wherein, in response to the batch download request from said client-side mail server, said center-side mail server transfers the bulk mail data to said client-side mail server using said batch transfer means.

3. The mail processing system according to claim 1,
wherein said individual-mail delivery means of said client-side mail server restores the bulk mail data to individual electronic mail data, saves each electronic mail in a mailbox corresponding to a destination mail address and, in response to a request from a mail client in the client organization, forwards the electronic mail in a corresponding mailbox to the mail client.

4. The mail processing system according to claim 2, further comprising:
correspondence relation means for maintaining correspondence between client organizations and center-side mail servers responsible for the client organizations;
correspondence relation management means for supervising a status of the center-side mail servers, for designating a center-side mail server as the center-side mail server responsible for the client organizations upon detecting that the currently designated center-side mail server has failed, and for updating information on the correspondence relation held in said correspondence relation holding means according to the redesignation of the center-side mail server; and
correspondence relation information providing means for providing information to the client-side mail servers, said information indicating the center-side mail servers to which the client-side mail servers are to send batch download requests.

5. A mail processing device for providing electronic mail processing services to a client organization, comprising:
receiving means for receiving electronic mail having mail a address indicating the client organization as a destination;
storing means for storing the electronic mail received by said receiving means; and
batch transfer means for transferring bulk mail data to a client-side mail server installed in the client organization, said bulk mail data being created by combining electronic mail, which is stored on said storing means and addressed to mail addresses within said client organization, into one unit.

6. The mail processing device according to claim 5,
wherein said batch transfer means transfers the bulk mail data to said client-side mail server only when a batch download request is received from the client-side mail server.

7. The mail processing device according to claim 6,
wherein, in response to a batch download request from said client-side mail server, said batch transfer means creates bulk mail data by extracting electronic mail, which belongs to the mail addresses within the client organization corresponding to the client-side mail server, from the electronic mail stored on said storing means and then transfers the created bulk mail data to the client-side mail server.

8. A device for providing electronic mail processing services to a client organization, comprising:
bulk mail receiving means for receiving bulk mail data from a predetermined center-side mail server, said bulk mail data being created by combining electronic mail addressed to mail addresses within a client organization for which the device is responsible into one unit; and
individual-mail delivery means for extracting individual electronic mail from the received bulk mail data and providing the extracted electronic mail to destination mail addresses.

9. The device according to claim 8,
wherein said bulk mail receiving means sends a download request to said center-side mail server at a time determined according to a predetermined condition and receives the bulk mail data transferred from said center-side mail server in response to the download request.

10. A method for providing electronic mail processing services to a client organization, comprising the steps of:
installing a client-side mail server that provides electronic mail processing services to mail clients in the client organization;
installing a center-side mail server that provides electronic mail processing services to the client-side mail server;
causing said center-side mail server to:
receive electronic mail addressed to mail addresses within the client organization on behalf of said client-side mail server in the client organization and store the electronic mail in predetermined storing means;
create bulk mail data by combining electronic mailstored on said storing means and addressed to the mail addresses within the client organization into one unit; and
transfer the bulk mail data to the client-side mail server in the client organization; and
causing said client-side mail server to:
receive the bulk mail data transferred from said center-side mail server; and
deliver the electronic mail to the mail addresses within the client organization for which the client-side mail server is responsible based on the received bulk mail data.

11. The method according to claim 10,
wherein said client-side mail server sends a batch download request to said center-side mail server and
wherein said center-side mail server transfers the bulk mail data to the client-side mail server only when the batch download request is received from said client-side mail server.

12. The mail processing method according to claim 10, wherein a network to which the method is applied includes a plurality of client organizations and a plurality of center-side mail servers and wherein one or more center-side mail servers are assigned to each of said client organizations, said method further comprising the steps of:
supervising the status of the center-side mail servers;
upon detecting that one of said center-side mail servers fails, designating another center-side mail server as the server responsible for a client organization for which the failed center-side mail server has theretofore been responsible;
when the center-side mail server responsible for the client organization is changed, notifying the client-side mail server in the client organization, which is associated with the change, of the new center-side mail responsible for the client organization; and
sending, by the client-side mail server, the batch download request to said new center-side mail server.

13. A method for providing electronic mail processing services to a client organization, comprising the steps of:
storing electronic mail by receiving the electronic mail addressed to mail addresses within said client organization; and
transferring bulk mail data to a client-side mail server installed in the client organization, said bulk mail data being created by combining stored electronic mail addressed to mail addresses within said client organization, into one unit.

14. The method according to claim 13,
wherein, in said step of transferring the bulk mail data to said client-side mail server, the bulk mail data is transferred to said client-side mail server only when a batch download request is received from said client-side mail server.

15. The method according to claim 14,
wherein, in said step of transferring the bulk mail data to said client-side mail server, the bulk mail data is created in response to the batch download request from said client-side mail server by extracting electronic mail, which is included in the stored electronic mail and which belongs to the mail addresses within the client organization corresponding to the client-side mail server, and is then transferred to the client-side mail server.

16. A method for providing electronic mail processing services to a client organization, comprising the steps of:
receiving bulk mail data from a predetermined center-side mail server, said bulk mail data being created by combining electronic mail addressed to addresses within the client organization, into one unit; and
extracting individual electronic mail from the received bulk mail data to provide the extracted electronic mail to destination mail addresses.

17. The method according to claim 16,
wherein, in said step of receiving bulk mail data, a download request is sent to the predetermined center-side mail server at a time determined according to a predetermined condition and the bulk mail data transferred from said center-side mail server is received in response to the download request.

18. A computer-readable storage medium having stored therein a computer program for causing a computer system to execute the steps of:
storing electronic mail by receiving electronic mail addressed to mail addresses within a client organization to which services are to be provided; and
batch-transferring bulk mail data to a client-side mail server corresponding to the client organization, said bulk mail data being created by combining electronic mail, which is stored in said storing step and addressed to the mail addresses within the client organization, into one unit.

19. The storage medium according to claim 18,
wherein, in said step of batch-transferring bulk mail data, the bulk mail data is transferred to said client-side mail server only when a batch download request is received from said client-side mail server.

20. The storage medium according to claim 19,
wherein, in said step of batch-transferring bulk mail data, the bulk mail data is created in response to the batch download request from said client-side mail server by extracting electronic mail included in the stored electronic mail and addressed to the mail addresses corresponding to the client-side mail server, and is then transferred to the client-side mail server.

21. A computer-readable storage medium having stored therein a computer program for causing a computer system to execute the steps of:
receiving bulk mail data from a predetermined center-side mail server, said bulk mail data being created by combining electronic mail addressed to mail addresses within a client organization into one unit; and
extracting individual electronic mail from the received bulk mail data to provide the extracted electronic mail to destination mail addresses.

22. The storage medium according to claim 21,
wherein, in said step of receiving bulk mail data, a download request is sent to the predetermined center-side mail server at a time determined according to a predetermined condition in order to retrieve the bulk mail data transferred from said center-side mail server in response to the download request.
